(19) United States
(12) Patent Application Publication
(10) Pub. No.: US 2025/0372875 A1
(43) Pub. Date: Dec. 4, 2025

(54) ANTENNA ASSEMBLY AND ANTENNA

(71) Applicant: HUAWEI TECHNOLOGIES CO., LTD., Shenzhen (CN)

(72) Inventors: Biao Pu, Dongguan (CN); Haiwei Zhang, Dongguan (CN); Yuzhi Ding, Dongguan (CN); Yiliang Zhang, Shanghai (CN); Hua Chen, Dongguan (CN); Zhongwei Peng, Dongguan (CN)

(73) Assignee: HUAWEI TECHNOLOGIES CO., LTD., Shenzhen (CN)

(21) Appl. No.: 19/301,041

(22) Filed: Aug. 15, 2025

Related U.S. Application Data
(63) Continuation of application No. PCT/CN2024/077036, filed on Feb. 8, 2024.

(30) Foreign Application Priority Data
Feb. 17, 2023 (CN) 202310175508.4

(51) Int. Cl. H01Q 9/06

(52) U.S. Cl. CPC H01Q 9/065

(57) ABSTRACT

An antenna assembly includes a substrate, a feed network, a radiating element, and a reflection panel. The radiating element and the reflection panel are respectively disposed on two sides of the substrate. The feed network is electrically connected to the radiating element. The feed network includes a flat strip layer and a curved strip layer. The flat strip layer is disposed on a surface that is of the substrate and that is close to the reflection panel. The curved strip layer is disposed on a surface of the substrate and connected to the flat strip layer. When the feed network transmits energy, a first electric field component formed by the flat strip layer may be directly radiated to the reflection panel, and a second electric field component formed by the curved strip layer may also be directly radiated to the reflection panel.

### CROSS-REFERENCE TO RELATED APPLICATIONS

This application is a continuation of International Application No. PCT/CN2024/077036, filed on Feb. 8, 2024, which claims priority to Chinese Patent Application No. 202310175508.4, filed on Feb. 17, 2023. The disclosures of the aforementioned applications are hereby incorporated by reference in their entireties.

### TECHNICAL FIELD

This application relates to the field of communication technologies, and in particular, to an antenna assembly and an antenna.

### BACKGROUND

As communication technologies develop, an antenna system of a base station evolves from 4th generation mobile networks (4G) to 5th generation mobile networks (5G). Featuring miniaturization, lightweight, high performance, and the like, a massive multiple-input multiple-output (MIMO) technology has attracted much attention in academia and industry in recent years and become a main physical layer technology of 5G. As an evolution of a multi-user MIMO technology, massive MIMO not only simultaneously serves a larger quantity of users, but also simplifies multi-user processing, reduces transmission power, and provides a higher overall rate.

Currently, common MIMO antenna array solutions mainly include a PCB array and a plastic electroplating-based array. The plastic electroplating-based array is implemented by electroplating, on a plastic substrate, a radiating element array of one or more antenna frequency bands and a feed network thereof, metal plating capable of transmitting a radio frequency signal, and a reflection ground for reflecting a signal.

However, because an electroplated element, an element feed network, and a radiating element are all electroplated on a surface of the plastic substrate, an electroplated strip of the element feed network penetrates the plastic substrate during energy transmission, resulting in a loss. Therefore, how to implement a low-loss MIMO antenna array is an urgent technical problem to be resolved.

### SUMMARY

This application provides an antenna assembly and an antenna, to reduce a loss of transmitted energy, thereby improving signal transmission stability and a gain of the antenna.

According to a first aspect, this application provides an antenna assembly. For example, the antenna assembly may include a substrate, a feed network, a radiating element, and a reflection panel. The radiating element and the reflection panel are respectively disposed on two sides of the substrate. The feed network may be electrically connected to the radiating element, so that the radiating element is fed by the feed network. The feed network includes a flat strip layer and a curved strip layer. The flat strip layer is disposed on a surface that is of the substrate and that is close to the reflection panel. The curved strip layer is disposed on a surface of the substrate. In addition, the curved strip layer is connected to the flat strip layer. When the feed network transmits energy, the flat strip layer is configured to form a first electric field component directly radiated to the reflection panel, and the curved strip layer is configured to form a second electric field component directly radiated to the reflection panel.

When the antenna assembly is used in an antenna, the feed network may feed the radiating element. The first electric field component formed by the flat strip layer may be directly radiated to the reflection panel, and the second electric field component formed by the curved strip layer may also be directly radiated to the reflection panel, to reduce energy attenuation that occurs because an electric field formed by the feed network passes through the substrate. This reduces a loss of the transmitted energy, to improve signal transmission stability and a gain of the antenna.

When the feed network is disposed, the position and the shape of the feed network are not limited. For example, the flat strip layer and the curved strip layer may be disposed on different surfaces of the substrate. In an embodiment, the curved strip layer may be disposed on a surface that is of the substrate and that is away from the reflection panel. In addition, the curved strip layer may extend along the surface of the substrate to a surface that is of the substrate and that is close to the reflection panel, and be connected to the flat strip layer. In this way, the first electric field component can be radiated to the reflection panel, and the second electric field component can be radiated to the reflection panel from the side that is of the substrate and that is away from the reflection panel, so that the electric field formed by the feed network can be radiated from the two sides of the substrate to the reflection panel. This reduces the energy attenuation that occurs because the electric field passes through the substrate.

In an embodiment, the substrate may include a first body, a second body, and a plurality of connection portions. The plurality of connection portions are connected between the first body and the second body at intervals. The second body is disposed close to the reflection panel. In this technical solution, the curved strip layer and the flat strip layer may form an annular strip layer, and be disposed around the second body, to form a three-dimensionally distributed electric field.

In another embodiment, the substrate may be provided with a connection hole. The connection hole penetrates from a surface that is of the substrate and that is away from the reflection panel to the surface that is of the substrate and that is close to the reflection panel. The curved strip layer is on a surface that is of the substrate and that is away from the reflection panel. The curved strip layer extends through the connection hole and is connected to the flat strip layer, to form an electric field on the two sides of the substrate.

In addition, the flat strip layer and the curved strip layer may alternatively be disposed on a same surface of the substrate. For example, in an embodiment, the curved strip layer is on the surface that is of the substrate and that is close to the reflection panel, and protrudes toward the reflection panel. A surface that is of the reflection panel and that is close to the substrate has a first recess portion. The curved strip layer is accommodated in the first recess portion.

A shape of a cross section that is of the curved strip layer and that is perpendicular to the substrate includes a V shape, a U shape, or an arc shape. A shape of a cross section that is of the first recess portion and that is perpendicular to the reflection panel is the same as the shape of the cross section that is of the curved strip layer and that is perpendicular to the substrate.

In another embodiment, the antenna assembly may further include a power division network. The substrate includes a third body, a first support portion, and a second support portion. The first support portion, the second support portion, and the power division network are disposed on a surface that is of the third body and that is close to the reflection panel. The power division network is between the first support portion and the second support portion. The antenna assembly includes a first feed network and a second feed network. The first feed network is disposed on a surface of the first support portion. The second feed network is disposed on a surface of the second support portion. A surface that is of the reflection panel and that is close to the substrate has a second recess portion and a third recess portion. The first support portion is accommodated in the second recess portion. The second support portion is accommodated in the third recess portion.

In the foregoing antenna assembly, the positions of the first feed network and the second feed network are not limited. For example, in an embodiment, the first feed network may be disposed around a periphery of the first support portion, and the second feed network may be disposed around a periphery of the second support portion, to form annular feed networks on the peripheries of the first support portion and the second support portion.

In another embodiment, the first feed network may cover an end portion that is of the first support portion and that is accommodated in the second recess portion, and the second feed network may cover an end portion that is of the second support portion and that is accommodated in the third recess portion. This increases a relative area of the feed network and the reflection panel, to further reduce the energy attenuation and improve space utilization.

According to a second aspect, this application further provides an antenna. The antenna includes a mounting bracket and the antenna assembly according to the first aspect. The antenna assembly is disposed on the mounting bracket. When the antenna is in use, the feed network may feed the radiating element. The first electric field component formed by the flat strip layer may be directly radiated to the reflection panel, and the second electric field component formed by the curved strip layer may also be directly radiated to the reflection panel, to reduce energy attenuation that occurs because an electric field formed by the feed network passes through the substrate. This reduces a loss of the transmitted energy, to improve signal transmission stability and a gain of the antenna.

### BRIEF DESCRIPTION OF DRAWINGS

FIG. 1 is a principle diagram of a MIMO antenna;

FIG. 2 is another principle diagram of a MIMO antenna;

FIG. 3 is a diagram of a structure of an antenna assembly according to an embodiment of this application;

FIG. 4 is a schematic partial view of the antenna assembly in FIG. 3;

FIG. 5 is a diagram of another structure of an antenna assembly according to an embodiment of this application;

FIG. 6 is a schematic partial view of the antenna assembly in FIG. 5;

FIG. 7 is a diagram of another structure of an antenna assembly according to an embodiment of this application;

FIG. 8 is a schematic partial view of the antenna assembly in FIG. 7;

FIG. 9 is a diagram of another structure of an antenna assembly according to an embodiment of this application;

FIG. 10 is a schematic partial view of the antenna assembly in FIG. 9;

FIG. 11 is a diagram of another structure of an antenna assembly according to an embodiment of this application;

FIG. 12 is a schematic partial view of the antenna assembly in FIG. 11;

FIG. 13 is a diagram of another structure of an antenna assembly according to an embodiment of this application;

FIG. 14 is a schematic partial view of the antenna assembly in FIG. 13;

FIG. 15 is a diagram of another structure of an antenna assembly according to an embodiment of this application;

FIG. 16 is a schematic partial view of the antenna assembly in FIG. 15;

FIG. 17 is a diagram of another structure of an antenna assembly according to an embodiment of this application;

FIG. 18 is a schematic partial view of the antenna assembly in FIG. 17;

FIG. 19 is a diagram of another structure of an antenna assembly according to an embodiment of this application; and

FIG. 20 is a schematic partial view of the antenna assembly in FIG. 19.

### REFERENCE NUMERALS

01: plastic substrate;
02: element feed network;
03: reflection panel;
30: substrate;
31: feed network;
31a: first feed network;
31b: second feed network;
32: reflection panel;
301: first body;
302: second body;
303: connection portion;
304: connection hole;
305: third body;
306: first support portion;
307: second support portion;
308: first end portion;
309: second end portion;
311: flat strip layer;
312: curved strip layer;
321: first recess portion;
322: second recess portion;
323: third recess portion.

### DESCRIPTION OF EMBODIMENTS

To make objectives, technical solutions, and advantages of this application clearer, the following further describes this application in detail with reference to the accompanying drawings.

Reference to “an embodiment”, “some embodiments”, or the like described in this specification indicates that one or more embodiments of this application include a specific feature, structure, or characteristic described with reference to embodiments. Therefore, statements such as “in an embodiment”, “in another embodiment”, “in some embodiments”, “in some other embodiments”, or “in other embodiments” that appear at different places in this specification do not necessarily mean reference to a same embodiment. Instead, the statements mean “one or more but not all of embodiments”, unless otherwise emphasized in another manner. The terms “include”, “comprise”, “have”, and their variants all mean “include but are not limited to”, unless otherwise emphasized in another manner.

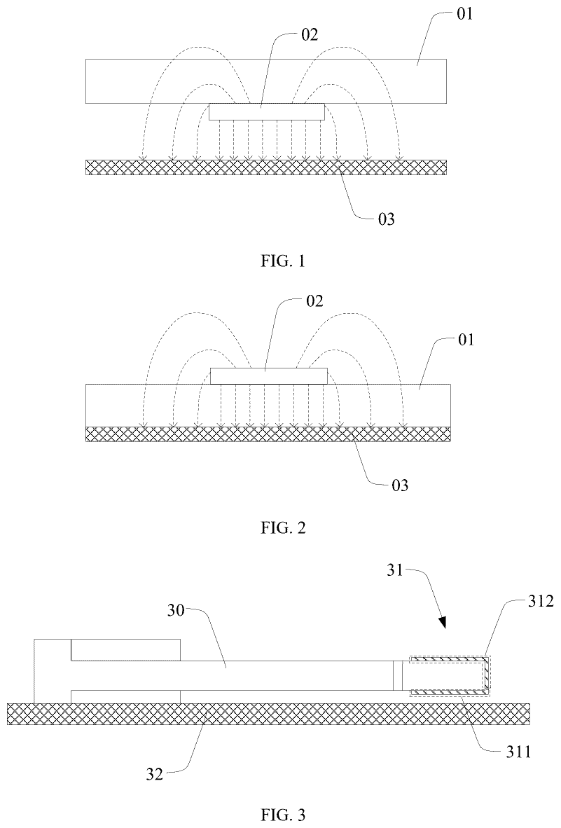

Currently, a common MIMO antenna mainly uses a plastic electroplating-based array. For example, the antenna includes a plastic substrate, a radiating element, an element feed network, and a reflection panel. The radiating element and the element feed network may be electroplated on a surface of the plastic substrate. FIG. 1 is a principle diagram of a MIMO antenna. As shown in FIG. 1, in a MIMO antenna structure, an element feed network 02 and a reflection panel 03 are disposed on a same side of a plastic substrate 01. The element feed network 02 is an electroplated strip electroplated on a surface that is of the plastic substrate 01 and that is close to the reflection panel 03. When the element feed network 02 transmits energy, the element feed network 02 radiates an electric field (as shown by dashed lines in FIG. 1) to surroundings. A component that is of the electric field and that is close to the plastic substrate 01 needs to pass through the plastic substrate 01 before reaching the reflection panel 03. However, in a process of penetrating the plastic substrate 01, energy radiated by the element feed network 02 is attenuated. Consequently, a gain of the antenna is unsatisfactory. FIG. 2 is another principle diagram of a MIMO antenna. As shown in FIG. 2, in another MIMO antenna structure, an element feed network 02 and a reflection panel 03 are respectively disposed on two sides of a plastic substrate 01. When the element feed network 02 transmits energy, the element feed network 02 radiates an electric field (as shown by dashed lines in FIG. 2) to surroundings. All components of the electric field that are radiated to the reflection panel 03 need to pass through the plastic substrate 01 before reaching the reflection panel 03, which also causes energy attenuation.

In view of the foregoing technical problem, this application provides an antenna assembly and an antenna, to reduce a loss of transmitted energy, thereby improving signal transmission stability and a gain of the antenna.

FIG. 3 is a diagram of a structure of an antenna assembly according to an embodiment of this application. As shown in FIG. 3, the antenna assembly may include a substrate 30, a feed network 31, a radiating element (not shown in the figure), and a reflection panel 32. For example, the radiating element and the reflection panel 32 are respectively disposed on two sides of the substrate 30. The feed network 31 is electrically connected to the radiating element, so that the radiating element can be fed by the feed network 31. In embodiments of this application, the radiating element may be directly disposed on a surface that is of the substrate 30 and that is away from the reflection panel 32. Alternatively, the antenna assembly may further include a fastener. The radiating element, the substrate 30, and the reflection panel 32 are fastened to the fastener. The feed network 31 may include a flat strip layer 311 and a curved strip layer 312. The flat strip layer 311 is disposed on a surface that is of the substrate 30 and that is close to the reflection panel 32. The curved strip layer 312 is disposed on a surface of the substrate 30. Their positions are not limited. The curved strip layer 312 is connected to the flat strip layer 311 to form the feed network 31. In other words, the two strip layers of the feed network 31 may be disposed on a same surface of the substrate 30 or different surfaces of the substrate 30. Therefore, when the antenna assembly is used in an antenna, the feed network 31 is configured to transmit energy. A first electric field component formed by the flat strip layer 311 may be directly radiated to the reflection panel 32, and a second electric field component formed by the curved strip layer 312 may also be directly radiated to the reflection panel 32, to reduce energy attenuation that occurs because an electric field formed by the feed network 31 passes through the substrate 30. This reduces a loss of the transmitted energy, to improve signal transmission stability and a gain of the antenna.

In this embodiment, the electrical connection between the feed network 31 and the radiating element may be a physical connection. In other words, the feed network 31 is directly connected to the radiating element. Alternatively, the feed network 31 may not be physically connected to the radiating element, but may be electrically connected to the radiating element through coupling. In addition, because the curved strip layer 312 has a curved shape, a surface at a position that is of the substrate 30 and at which the curved strip layer 312 is disposed may also be set to a corresponding curved surface.

In this application, a size of the feed network 31 is not limited. For example, in an embodiment, the size of the feed network 31 may be less than that of a surface of the substrate 30. In other words, the feed network 31 may cover a partial surface of the substrate 30. In another embodiment, the size of the feed network 31 may be equal to that of the surface of the substrate 30. In other words, the feed network 31 may completely cover the surface of the substrate 30.

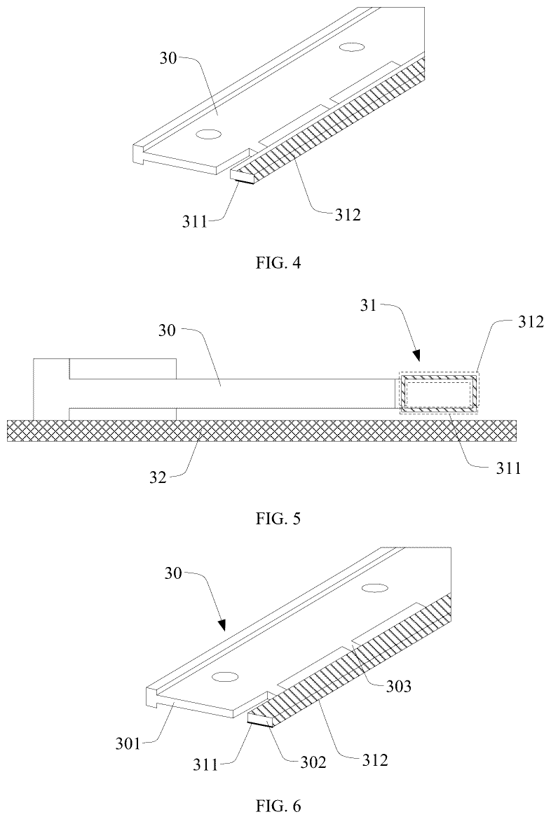

When the antenna assembly is disposed, the feed network 31 may be implemented in different manners. For example, in some embodiments, the flat strip layer 311 and the curved strip layer 312 may be disposed on different surfaces of the substrate 30. FIG. 4 is a schematic partial view of the antenna assembly in FIG. 3. As shown in FIG. 3 and FIG. 4, in an embodiment, the curved strip layer 312 may be disposed on a surface that is of the substrate 30 and that is away from the reflection panel 32. In addition, the curved strip layer 312 may extend along the surface of the substrate 30 to a surface that is of the substrate 30 and that is close to the reflection panel 32, and be connected to the flat strip layer 311. In this way, the first electric field component can be radiated to the reflection panel 32, and the second electric field component can be radiated to the reflection panel 32 from the side that is of the substrate 30 and that is away from the reflection panel 32, so that the electric field formed by the feed network 31 can be radiated from the two sides of the substrate 30 to the reflection panel 32, to form a three-dimensionally distributed electric field. This reduces the energy attenuation that occurs because the electric field passes through the substrate 30.

FIG. 5 is a diagram of another structure of an antenna assembly according to an embodiment of this application. FIG. 6 is a schematic partial view of the antenna assembly in FIG. 5. As shown in FIG. 5 and FIG. 6, in another embodiment, the substrate 30 may include a first body 301, a second body 302, and a plurality of connection portions 303. The first body 301 and the second body 302 are arranged side by side on a side of the reflection panel 32. The plurality of connection portions 303 are connected between the first body 301 and the second body 302 at intervals. The second body 302 is disposed close to the reflection panel 32. In this embodiment, the curved strip layer 312 and the flat strip layer 311 may form an annular strip layer, and be disposed around the second body 302, to form an electric field surrounding the second body 302. This further reduces the energy attenuation. In this embodiment, a shape of a cross section that is of the second body 302 and that is perpendicular to the substrate 30 may be a rectangle, a circle, an ellipse, or an irregular shape. This is not limited herein.

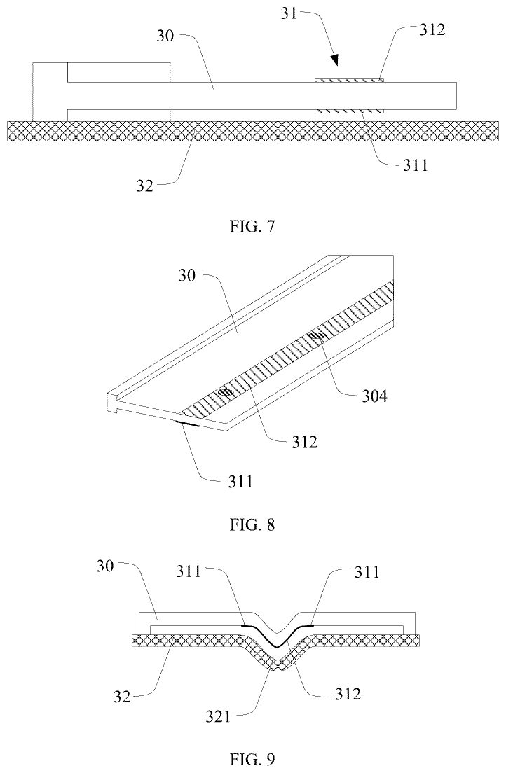

FIG. 7 is a diagram of another structure of an antenna assembly according to an embodiment of this application. FIG. 8 is a schematic partial view of the antenna assembly in FIG. 7. As shown in FIG. 7 and FIG. 8, the substrate 30 is provided with a connection hole 304. The connection hole 304 may penetrate from the surface that is of the substrate 30 and that is away from the reflection panel 32 to the surface that is of the substrate 30 and that is close to the reflection panel 32. The curved strip layer 312 is on a surface that is of the substrate 30 and that is away from the reflection panel 32. The curved strip layer 312 extends through the connection hole 304 and is connected to the flat strip layer 311, to form an electric field on the two sides of the substrate 30.

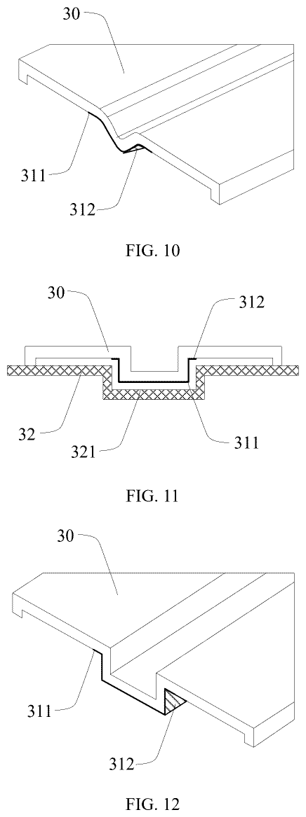

In some other embodiments, the flat strip layer 311 and the curved strip layer 312 may alternatively be disposed on a same surface of the substrate 30. FIG. 9 is a diagram of another structure of an antenna assembly according to an embodiment of this application. FIG. 10 is a schematic partial view of the antenna assembly in FIG. 9. As shown in FIG. 9 and FIG. 10, in an embodiment, the substrate 30 may be disposed parallel to and opposite to the reflection panel 32. The curved strip layer 312 is on the surface that is of the substrate 30 and that is close to the reflection panel 32, and protrudes toward the reflection panel 32. A surface that is of the reflection panel 32 and that is close to the substrate 30 has a first recess portion 321. The curved strip layer 312 is accommodated in the first recess portion 321. Therefore, when the feed network 31 transmits energy, the electric field component generated by the curved strip layer 312 may be directly radiated to the reflection panel 32, to reduce the energy attenuation that occurs because the electric field passes through the substrate 30. In this embodiment, the flat strip layer 311 may be disposed on peripheral sides of the curved strip layer 312, and is connected to the curved strip layer 312. In this way, the flat strip layer 311 and the curved strip layer 312 jointly form the feed network 31 with a protrusion in the middle, so that the feed network 31 has a three-dimensional shape, to improve space utilization and facilitate miniaturization of the antenna assembly.

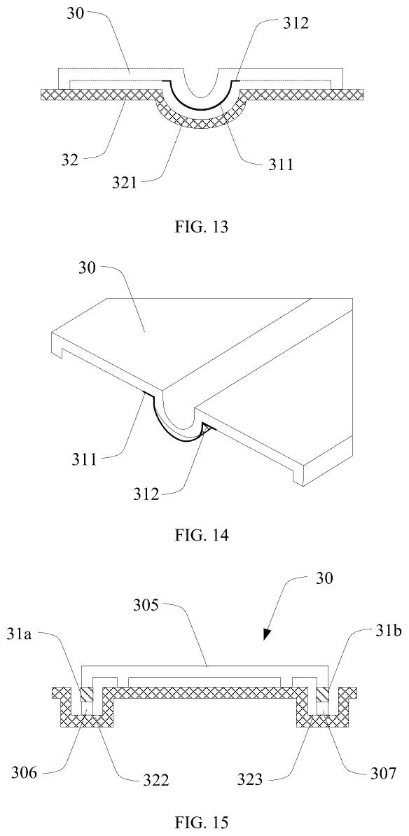

In embodiments of this application, the curved strip layer 312 may have a surface with a fold line or smooth transition. In the foregoing embodiment, a shape of a cross section that is of the curved strip layer 312 and that is perpendicular to the substrate 30 is not limited to a V shape in FIG. 9 and FIG. 10. FIG. 11 is a diagram of another structure of an antenna assembly according to an embodiment of this application. FIG. 12 is a schematic partial view of the antenna assembly in FIG. 11. As shown in FIG. 11 and FIG. 12, the shape of the cross section of the curved strip layer 312 may alternatively be a U shape. FIG. 13 is a diagram of another structure of an antenna assembly according to an embodiment of this application. FIG. 14 is a schematic partial view of the antenna assembly in FIG. 13. As shown in FIG. 13 and FIG. 14, the shape of the cross section of the curved strip layer 312 may alternatively be an arc shape. Certainly, the shape of the cross section of the curved strip layer 312 may alternatively be an irregular shape, for example, may be a shape combining a fold-line shape and the arc shape. This is not limited in this application. Correspondingly, a shape of a cross section that is of the first recess portion 321 and that is perpendicular to the reflection panel 32 is the same as the shape of the cross section that is of the curved strip layer 312 and that is perpendicular to the substrate 30, so that the electric field component radiated by the curved strip layer 312 can be directly radiated to the first recess portion 321.

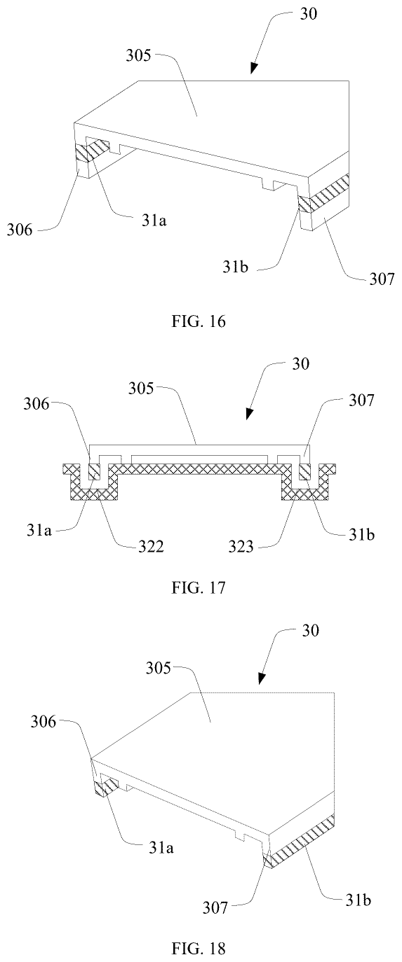

When the antenna assembly is actually disposed, the antenna assembly may further include a power division network. FIG. 15 is a diagram of another structure of an antenna assembly according to an embodiment of this application. FIG. 16 is a schematic partial view of the antenna assembly in FIG. 15. As shown in FIG. 15 and FIG. 16, in this embodiment, the substrate 30 includes a third body 305, a first support portion 306, and a second support portion 307. The first support portion 306, the second support portion 307, and the power division network are disposed on a surface that is of the third body 305 and that is close to the reflection panel 32. The power division network is between the first support portion 306 and the second support portion 307. The antenna assembly includes a first feed network 31a and a second feed network 31b. The first feed network 31a is disposed on a surface of the first support portion 306. The second feed network 31b is disposed on a surface of the second support portion 307. A surface that is of the reflection panel 32 and that is close to the substrate 30 has a second recess portion 322 and a third recess portion 323. The first support portion 306 is accommodated in the second recess portion 322. The second support portion 307 is accommodated in the third recess portion 323. In this embodiment, the first feed network 31a and the second feed network 31b are disposed in edge space of the power division network, so that space utilization can be improved.

In the foregoing embodiment, specific positions of the first feed network 31a and the second feed network 31b are not limited. As shown in FIG. 15 and FIG. 16, in an embodiment, the first feed network 31a may be disposed around a periphery of the first support portion 306, and the second feed network 31b may be disposed around a periphery of the second support portion 307, to form annular feed networks on the peripheries of the first support portion 306 and the second support portion 307.

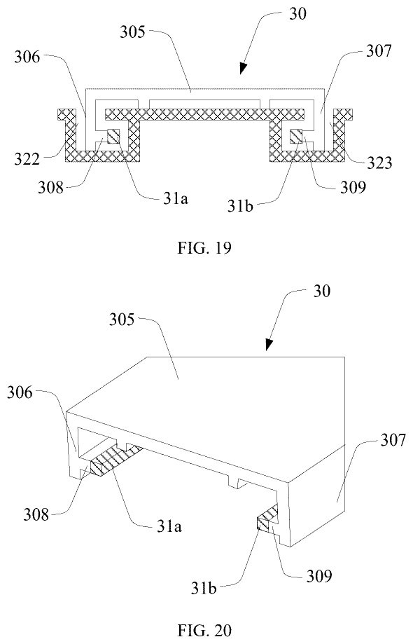

FIG. 17 is a diagram of another structure of an antenna assembly according to an embodiment of this application. FIG. 18 is a schematic partial view of the antenna assembly in FIG. 17. As shown in FIG. 17 and FIG. 18, in another specific embodiment, the first feed network 31a may cover an end portion that is of the first support portion 306 and that is accommodated in the second recess portion 322, and the second feed network 31b may cover an end portion that is of the second support portion 307 and that is accommodated in the third recess portion 323. This increases a relative area of the feed network 31 and the reflection panel 32, to further reduce the energy attenuation and improve space utilization. FIG. 19 is a diagram of another structure of an antenna assembly according to an embodiment of this application. FIG. 20 is a schematic partial view of the antenna assembly in FIG. 19. As shown in FIG. 19 and FIG. 20, the first support portion 306 has a first end portion 308, the second support portion 307 has a second end portion 309, and the first end portion 308 is disposed opposite to the second end portion 309. The first feed network 31a may cover the first end portion 308, and the second feed network 31b may cover the second end portion 309. This helps reduce a size of the antenna assembly in a direction perpendicular to the substrate 30 (for example, a vertical direction in FIG. 19), to further improve the space utilization.

Based on a same technical concept, this application further provides an antenna. The antenna includes a mounting bracket and the antenna assembly in any one of the foregoing embodiments. The antenna assembly is disposed on the mounting bracket. When the antenna is in use, the feed network 31 may feed the radiating element. A first electric field component formed by the flat strip layer 311 may be directly radiated to the reflection panel 32, and a second electric field component formed by the curved strip layer 312 may also be directly radiated to the reflection panel 32, to reduce energy attenuation that occurs because an electric field formed by the feed network 31 passes through the substrate 30. This reduces a loss of the transmitted energy, to improve signal transmission stability and a gain of the antenna.

Terms used in the foregoing embodiments are merely intended to describe specific embodiments, but are not intended to limit this application. The terms “one”, “a”, “an”, “the”, and “this” of singular forms used in this specification and the appended claims of this application are also intended to include expressions such as “one or more”, unless otherwise specified in the context clearly.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. An antenna assembly comprising:
a substrate;
a feed network;
a radiating element disposed on a first side of the substrate and electrically connected to the feed network; and
a reflection panel disposed on a second side of the substrate, wherein the feed network comprises a flat strip layer and a curved strip layer, the flat strip layer disposed on a first surface of the substrate and adjacent to the reflection panel, and the curved strip layer disposed on a second surface of the substrate and connected to the flat strip layer, wherein:
the flat strip layer is configured to form a first electric field component directly radiating to the reflection panel, and
the curved strip layer is configured to form a second electric field component directly radiating to the reflection panel.

2. The antenna assembly according to claim 1, wherein the curved strip layer is on a surface that is of the substrate and that is away from the reflection panel, and the curved strip layer extends along the surface of the substrate to a surface that is of the substrate and that is close to the reflection panel, and is connected to the flat strip layer.

3. The antenna assembly according to claim 2, wherein the substrate comprises a first body, a second body, and a plurality of connection portions, the plurality of connection portions are connected between the first body and the second body at intervals, and the second body is disposed close to the reflection panel; and
the curved strip layer and the flat strip layer form an annular strip layer, and are disposed around the second body.

4. The antenna assembly according to claim 1, wherein the substrate is provided with a connection hole, and the connection hole penetrates from a surface that is of the substrate and that is away from the reflection panel to the surface that is of the substrate and that is close to the reflection panel; and
the curved strip layer is on a surface that is of the substrate and that is away from the reflection panel, and the curved strip layer extends through the connection hole and is connected to the flat strip layer.

5. The antenna assembly according to claim 1, wherein the curved strip layer is on the surface that is of the substrate and that is close to the reflection panel, and protrudes toward the reflection panel; and a surface that is of the reflection panel and that is close to the substrate has a first recess portion, and the curved strip layer is accommodated in the first recess portion.

6. The antenna assembly according to claim 5, wherein a shape of a cross section that is of the curved strip layer and that is perpendicular to the substrate comprises a V shape, a U shape, or an arc shape, and a shape of a cross section that is of the first recess portion and that is perpendicular to the reflection panel is the same as the shape of the cross section that is of the curved strip layer and that is perpendicular to the substrate.

7. The antenna assembly according to claim 1, wherein the antenna assembly further comprises a power division network; the substrate comprises a third body, a first support portion, and a second support portion; the first support portion, the second support portion, and the power division network are disposed on a surface that is of the third body and that is close to the reflection panel; and the power division network is between the first support portion and the second support portion;
the antenna assembly comprises a first feed network and a second feed network, the first feed network is disposed on a surface of the first support portion, and the second feed network is disposed on a surface of the second support portion; and
a surface that is of the reflection panel and that is close to the substrate has a second recess portion and a third recess portion, the first support portion is accommodated in the second recess portion, and the second support portion is accommodated in the third recess portion.

8. The antenna assembly according to claim 7, wherein the first feed network is disposed around a periphery of the first support portion, and the second feed network is disposed around a periphery of the second support portion.

9. The antenna assembly according to claim 7, wherein the first feed network covers an end portion that is of the first support portion and that is accommodated in the second recess portion, and the second feed network covers an end portion that is of the second support portion and that is accommodated in the third recess portion.

10. An antenna, comprising:
a mounting bracket; and
an antenna assembly disposed on the mounting bracket;
the antenna assembly comprising:
a substrate,
a feed network,
a radiating element disposed on a first side of the substrate and electrically connected to the feed network, and
a reflection panel disposed on a second side of the substrate, wherein the feed network comprises a flat strip layer and a curved strip layer, the flat strip layer disposed on a first surface of the substrate and adjacent to the reflection panel, and the curved strip layer disposed on a second surface of the substrate and connected to the flat strip layer, wherein:
the flat strip layer is configured to form a first electric field component directly radiating to the reflection panel, and
the curved strip layer is configured to form a second electric field component directly radiating to the reflection panel.

11. The antenna according to claim 10, wherein the curved strip layer is on a surface that is of the substrate and that is away from the reflection panel, and the curved strip layer extends along the surface of the substrate to a surface that is of the substrate and that is close to the reflection panel, and is connected to the flat strip layer.

12. The antenna according to claim 11, wherein the substrate comprises a first body, a second body, and a plurality of connection portions, the plurality of connection portions are connected between the first body and the second body at intervals, and the second body is disposed close to the reflection panel; and
the curved strip layer and the flat strip layer form an annular strip layer, and are disposed around the second body.

13. The antenna according to claim 10, wherein the substrate is provided with a connection hole, and the connection hole penetrates from a surface that is of the substrate and that is away from the reflection panel to the surface that is of the substrate and that is close to the reflection panel; and
the curved strip layer is on a surface that is of the substrate and that is away from the reflection panel, and the curved strip layer extends through the connection hole and is connected to the flat strip layer.

14. The antenna according to claim 10, wherein the curved strip layer is on the surface that is of the substrate and that is close to the reflection panel, and protrudes toward the reflection panel; and a surface that is of the reflection panel and that is close to the substrate has a first recess portion, and the curved strip layer is accommodated in the first recess portion.

15. The antenna according to claim 14, wherein a shape of a cross section that is of the curved strip layer and that is perpendicular to the substrate comprises a V shape, a U shape, or an arc shape, and a shape of a cross section that is of the first recess portion and that is perpendicular to the reflection panel is the same as the shape of the cross section that is of the curved strip layer and that is perpendicular to the substrate.

16. The antenna according to claim 10, wherein the antenna assembly further comprises a power division network; the substrate comprises a third body, a first support portion, and a second support portion; the first support portion, the second support portion, and the power division network are disposed on a surface that is of the third body and that is close to the reflection panel; and the power division network is between the first support portion and the second support portion;
the antenna assembly comprises a first feed network and a second feed network, the first feed network is disposed on a surface of the first support portion, and the second feed network is disposed on a surface of the second support portion; and
a surface that is of the reflection panel and that is close to the substrate has a second recess portion and a third recess portion, the first support portion is accommodated in the second recess portion, and the second support portion is accommodated in the third recess portion.

17. The antenna according to claim 16, wherein the first feed network is disposed around a periphery of the first support portion, and the second feed network is disposed around a periphery of the second support portion.

18. The antenna according to claim 16, wherein the first feed network covers an end portion that is of the first support portion and that is accommodated in the second recess portion, and the second feed network covers an end portion that is of the second support portion and that is accommodated in the third recess portion.
